(19) United States
(12) Patent Application Publication
(10) Pub. No.: US 2002/0170038 A1
(43) Pub. Date: Nov. 14, 2002

(54) Method and apparatus for measuring performance of a multi-computer communication protocol on a single computer system

(76) Inventors: Bernard Yeh, Sunnyvale, CA (US); Buford M. Guy III, Pleasanton, CA (US); Mohammed B. Zaidi, Fremont, CA (US); Saikat ?quot;Roy?quot; Saharoy, Cupertino, CA (US)

Correspondence Address: KENYON & KENYON, Suite 600, 333 W. San Carlos Street, San Jose, CA, 95110-2711, US

(21) Appl. No.: 09/851,725

(22) Filed: May 8, 2001

(51) Int. Cl. G06F 9/44

(52) U.S. Cl. 717/131

(57) ABSTRACT

The present invention pertains to multi-computer communication systems and the testing of computer systems in such systems. To reduce expenditures in time and money, a computer system can be performance tested for a multi-computer communications environment without the necessity of creating a communications network. Instead the computer system under test executes server and client code and transmits data packets according to one more standard network communications protocols (e.g., SSL). Thread execution time is tracked along with the number of transactions completed between the execution of server code and the execution of client code. With this data, the performance of the computer system acting solely as a server or as a client can be determined.

### BACKGROUND OF THE INVENTION

The present invention pertains to a method and apparatus for measuring performance of a multi-computer communication protocol on a single computer system. More particularly, the present invention pertains to a method and apparatus where the performance of a single computer system is tested through the execution of instructions for two or more computer systems according to a multi-computer communication protocol.

A computer network is a system for interconnecting two or more computer systems together to allow for communication between them. Examples of computer networks include the Internet and World Wide Web as well as Local Area Networks (LANs), Wide Area Networks (WANs), intranets, and the like. Communication between computer systems over a computer network is typically controlled by a communication protocol. An example of such a protocol is TCP/IP (Transmission Control Protocol/Internet Protocol; IETF (Internet Engineering Task Force) RFC791 and RFC793). Protocols can be combined. For example, the SSL (Secure Sockets Layer Version 3.0) protocol, (HTTP, Version 1.1) HyperText Transport Protocol, Lightweight Directory Access Protocol (LDAP, Version 3.0), and or Internet Messaging Access Protocol (IMAP, version 4.0, IETF RFC 2060) can be used in combination with TCP/IP.

Software programs may be used to test the performance of a computer system. These software programs are sometimes referred to in the art as benchmarks. An example of such benchmark software is Winstone 2001 (Ziff-Davis, Inc.). For the most part, testing a single computer system using such software is generally a straight-forward process. Testing computer system performance in a multi-computer protocol is more difficult, however.

As an example, a configuration to be tested may include a server computer system and four client computer systems. To test the performance of the server computer system, a network is set up (e.g., a LAN) to allow communication between the server and the clients. Software code is then executed on each of the computer systems to simulate the communication between them according to one or more communication protocols. Benchmark software can then be run on each of the machines to test the performance of them.

There are several drawbacks to such a system. To test any single computer system (e.g., the server computer system or one of the client computer systems) requires that a computer network system be set up that includes not only the target computer system to be tested but a number of others to simulate a “real-world” environment. Doing so requires significant costs in resources as well as time (manpower is needed to manage the individual computer systems). Because a complete system is set up, the actual testing of one of the computer systems is not very portable.

In view of the above, there is a need for an improved method and apparatus for measuring performance of a multi-computer communication protocol on a single computer system.

### BRIEF DESCRIPTION OF THE DRAWINGS

FIG. 1 is a block diagram of a system for measuring performance of a multicomputer communication protocol on a single computer system.

FIG. 2 is a general block diagram of a computer system to be performance tested according to an embodiment of the present invention.

FIG. 3 is a general block diagram showing the interaction between the execution of threads in testing the performance of a computer system according to an embodiment of the present invention.

FIG. 4 is a flow diagram of server thread code execution according to an embodiment of the present invention.

FIG. 5 is a flow diagram of scheduler thread code execution according to an embodiment of the present invention.

FIG. 6 is a flow diagram of client thread code execution according to an embodiment of the present invention.

FIG. 7 is a flow diagram showing the collection of thread data according to an embodiment of the present invention.

FIG. 8 is a flow diagram of how protocol performance data is generated according to an embodiment of the present invention.

### DETAILED DESCRIPTION

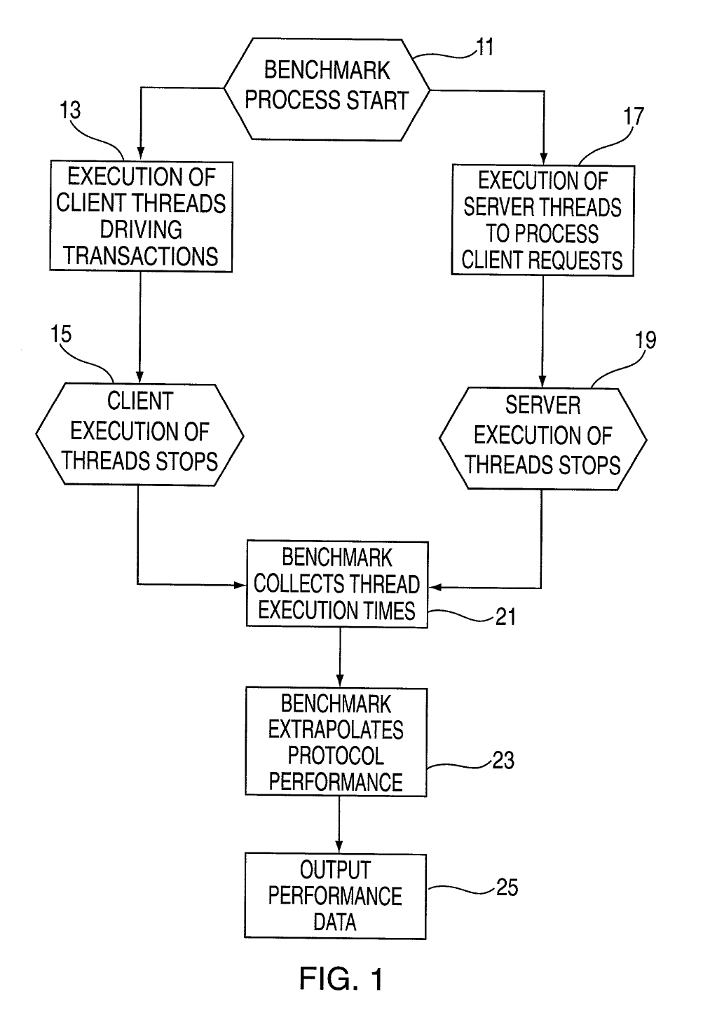

Referring to FIG. 1, a general block diagram showing the operation of the present invention is shown according to an embodiment of the present invention. In this embodiment, a software program is present on a storage media and is to be executed by one or more processors in the computer system to be tested. This software program is referred to herein as the benchmark. According to an embodiment of the present invention, there are several components of the benchmark. A first component includes software code that is to be executed by the computer system to be tested that corresponds to code that would be executed by a server computer system and one or more client computer systems. In this embodiment, the software code is divided into series of instruction code series referred to in the art as threads. Referring to FIG. 1, after the benchmark software is started on the computer system under test (block 11), threads are executed by the one or more clients in driving transactions (block 13) and threads are executed by the server in processing client requests (block 17). At some point client execution of threads stops (block 15) and server execution of threads stops (block 17).

A second component of the benchmark software collects code execution data, such as the amount of time that code is executed for server functions and the amount of time that is used for the execution of client functions. Thus, in FIG. 1, block 21 collects thread execution times for the server and client threads. A third component extrapolates performance data from the thread execution times (block 23) and presents performance data for the computer system being tested.

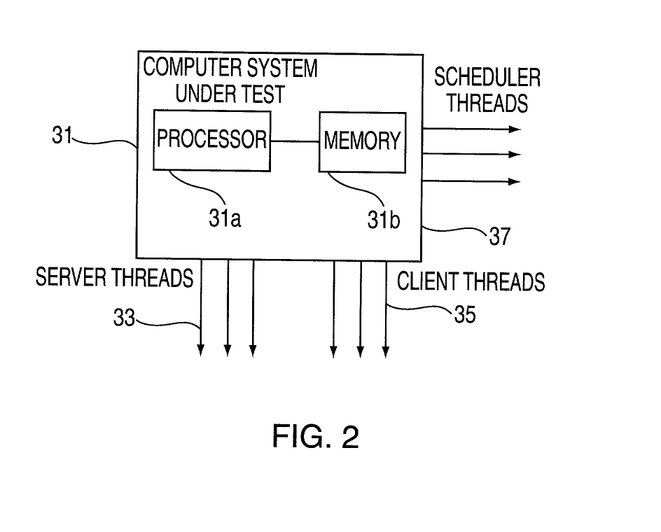

Referring to FIG. 2, a general block diagram of the computer system to be performance tested is shown. The computer system under test 31 (e.g., a server to be used in electronic commerce transactions over the Internet) includes at least one processor 31a and memory 31b. Memory 31b includes a variety of components for the storage of software code including random access memory, hard-disk drive, compact-disc read-only-memory (CD-ROM), etc. Processor 31a executes instruction code stored in memory 31b.

In this embodiment of the present invention, the instruction code or software to be executed by the processor is divided into a plurality of threads: server threads 33, client threads 35, and scheduler threads 37. Server threads make up the code that would be executed by the server to perform a variety of functions. In this embodiment, those functions include the receipt of transaction requests by a client, the processing of those transaction requests, and the transmission of appropriate responses to the client. For example, the server can be processing requests for information and credit card purchase transactions from the client. Client threads make up the code that would be executed by one or more client computer systems to perform a variety of functions. In this embodiment, those functions include the generation of requests for information, the generation of data (e.g., credit card data, ordering information, etc.), the transmission of the requests, data, etc. to the server, and the receipt of appropriate responses from the server. According to this embodiment, data that is to be transmitted between the server and the client(s) is formatted according to one or more network communication protocols (e.g., SSL). Scheduler threads make up the code that would be executed by the server to perform a variety of communication functions. Since a single computer is executing the server and client threads, the execution of the scheduler threads coordinates the communication of data (e.g., data packets conforming to the network communication protocol(s)) between the client threads and the server threads.

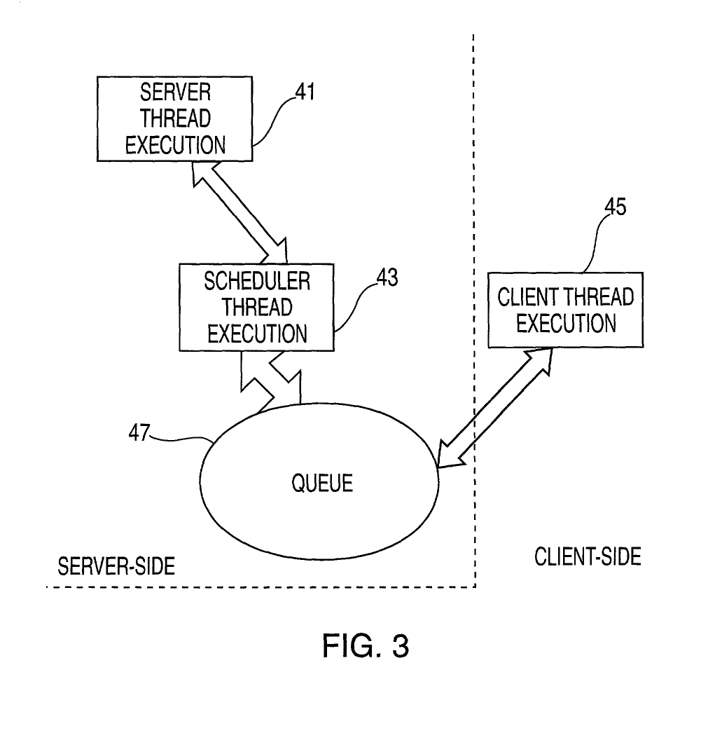

In this embodiment, data packets are transferred between the execution of server and client threads through sockets. A socket is a software concept known in the art that provides a communication input/output for software code execution. Typically, a socket provides the appropriate software interface to allow a data packet to be sent to the communication network. In this embodiment of the present invention, the communication network need not be present. Accordingly, when the execution of a client thread causes a data packet to transmitted to an identified socket, the execution of the scheduler thread causes the data packet to be stored in a queue. The relationship between the server, client, and scheduler threads is shown conceptually in FIG. 3.

Referring to FIG. 3, a general block diagram showing the interaction between various threads in the benchmark program is presented according to an embodiment of the present invention. The server thread execution 41 transmits and receives data packets from the scheduler thread execution 43. Likewise, the client thread execution 45 transmits and receives data packets from the scheduler thread execution 43. The scheduler thread execution interfaces with a queue 47 to temporarily store data packets so that they can be transferred and made available to the appropriate thread execution.

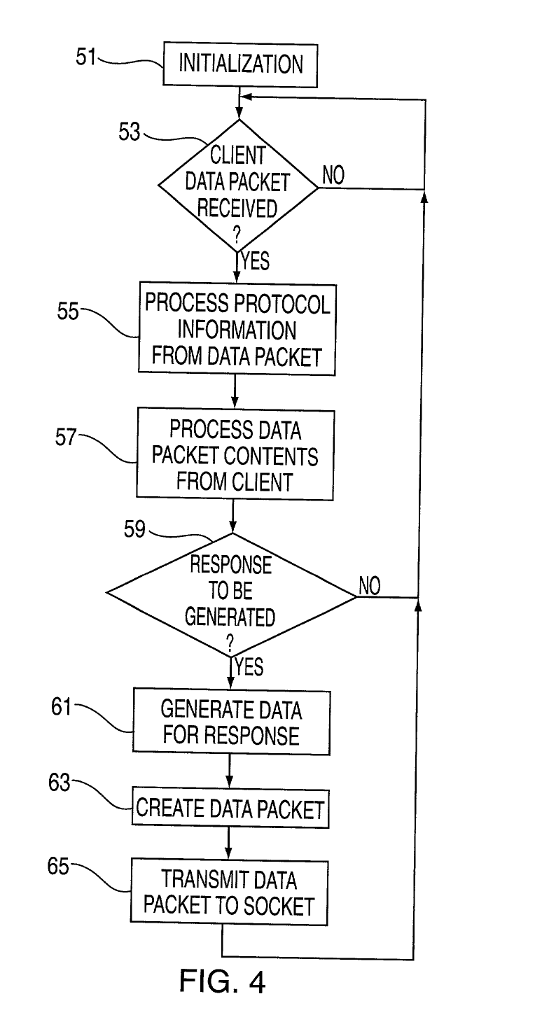

Referring to FIG. 4, a flow diagram of server thread code execution is shown according to an embodiment of the present invention. In block 51, the execution of the server code goes through an initialization phase so that the server is ready to accept communication from the client. In decision block 53, it is determined whether client data packet has been received (e.g., via the execution of scheduler code). If such a data packet has been received, then the protocol information for the data packet is processed (e.g., an SSL protocol or other network communication protocols) in block 55. In block 57 the data of the packet (e.g., sometimes referred to as the “payload”) is processed by the server code. In decision block 59 it is determined whether a response is to be generated. For example, if a client has transmitted data corresponding to an order including credit card information, the server may need to process that information and respond with a confirmation message to the appropriate client. In block 61, the data to be sent back to the client is generated through the execution of server code. In block 63, a server data packet is generated (e.g., according to the SSL protocol). In block 65, the data packet is transferred to the socket so that it will be eventually processed by the appropriate client code.

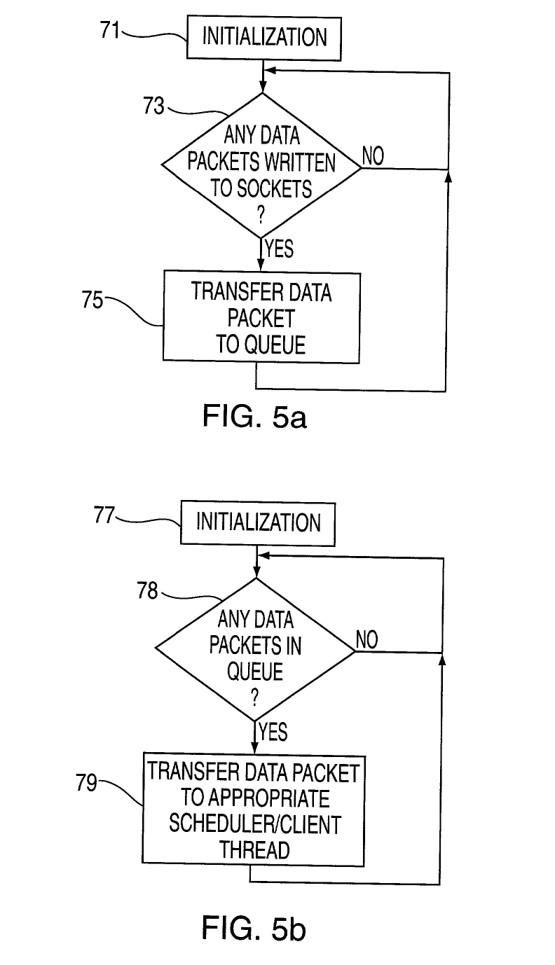

Referring to FIG. 5, a flow diagram of scheduler thread code execution is shown according to an embodiment of the present invention. In block 71, the execution of the scheduler code goes through an initialization phase so that the scheduler is ready to transfer data packets between the client/server threads and the queue. In decision block 73 it is determined whether there are any data packets that have been written to a socket (e.g., when the execution of a server thread is attempting to transfer a data packet to a client). If there is then control passes to block 75 to transfer the data packet to the queue (e.g., queue 47 in FIG. 3). In this embodiment, the execution of scheduler threads repeatedly look for data packets written to sockets so that they can be transferred, temporarily, to the queue. In this embodiment, the execution of scheduler threads repeatedly looks for data packets in the queue so that they can be transferred to the appropriate client/server threads.

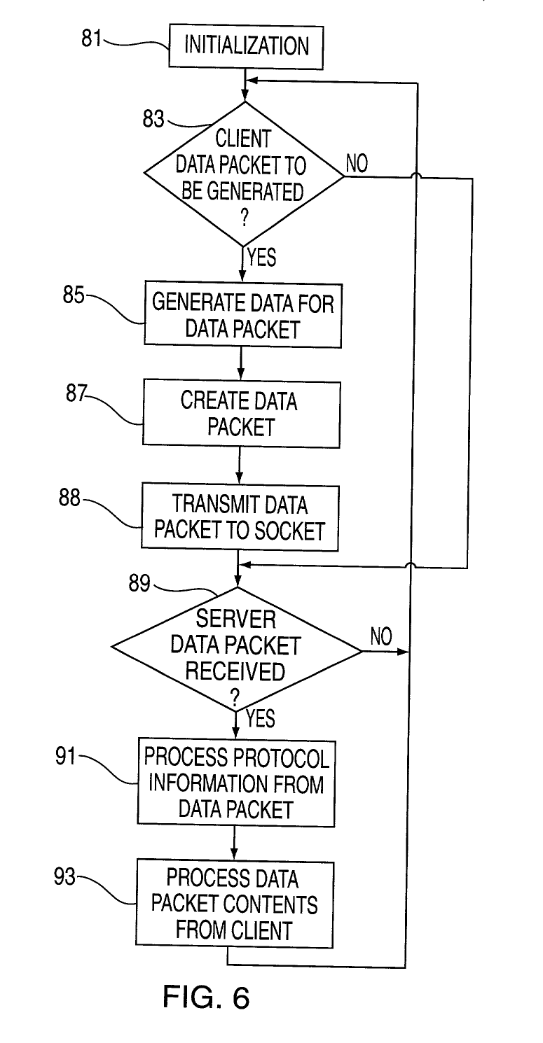

Referring to FIG. 6, a flow diagram of client thread execution is shown according to an embodiment of the present invention. In block 81, the execution of the client code goes through an initialization phase so that the client is ready to communicate with the server. In decision block 83, it is determined whether the client is to generate a data packet to be sent to the server (e.g., to initiate a request for data from the server). If so, control passes to block 85 where the data for a data packet is generated. In block 87, a client data packet is created using the appropriate protocol(s) (e.g., an SSL protocol or other network communication protocol(s)). In block 88, the data packet is sent to the socket so that it can be transferred to the execution of server code via the scheduler. In block 89, it is determined whether a response data packet has been received from the server. If so, then in block 91 the protocol information for the server data packet is processed (e.g., an SSL protocol or other network communication protocols). In block 93 the data of the packet is processed by the execution of client thread code.

In view of the flow diagrams of FIGS. 4-6, it will be appreciated that many variations may be presented for the server, client and scheduler threads, and that only one of many examples is presented.

With the desired server, scheduler and client threads, the benchmark execution (e.g., blocks 13 and 17 in FIG. 1) can proceed at the computer system under test 31 (FIG. 2). Depending on the processor being used and whether more than one such processor is being used in the computer system under test, the server, scheduler, and client threads will be executed sequentially or in parallel. Referring back to FIG. 1, in block 21, thread execution data is collected for each thread executed by the computer system under test. A variety of operating systems provide this type of data automatically. For example, in the Windows NT® operating system, each thread is identified by a 32-bit code, and the execution time for each thread is tracked and stored.

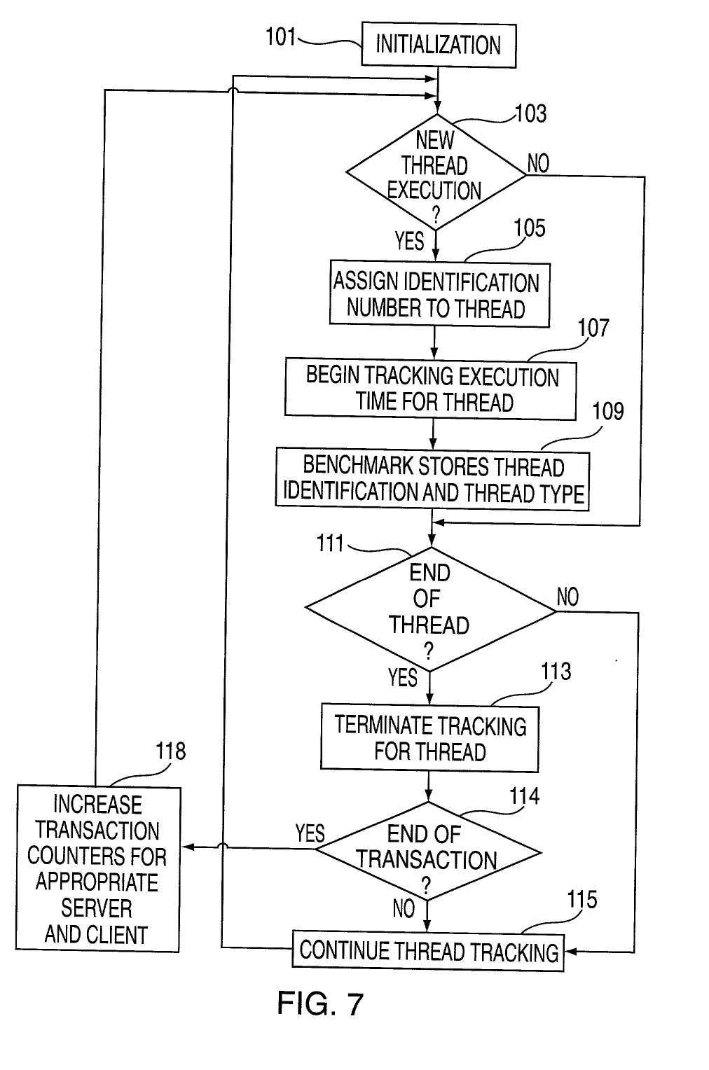

Referring to FIG. 7, a flow diagram of how this data is collected is shown according to an embodiment of the present invention. In block 101, an initialization phase is performed to get the system under test ready to perform thread execution time tracking. In decision block 103, it is determined whether the next instruction to be executed is part of a new thread (i.e., from one where the first instruction is being executed). If it is, then control passes to block 105 and an identification number is assigned to the thread. In block 107, the tracking of execution time for the thread begins and is to continue until the execution of the thread is stalled or completed. In block 109, the benchmark program stores the thread identification and thread type (e.g., whether the thread is a server, scheduler, or client thread). In block 111 it is determined whether the end of the execution of a thread has been reached. If so, then control passes to block 113 where the thread execution tracking for the thread is terminated. At this point, the thread execution time has been stored. As stated above, the Windows NT® operating system will automatically store thread execution times and identification numbers. These value can be retrieved and used as discussed herein. Other operating systems provide the same information. For example, the Solaris operating environment from Sun Microsystems, Inc. (Palo Alto, Calif.) can provide similar information on thread execution. In decision block 114 it is determined whether a transaction between a server and a client has ended. If it has, then in block 118, counters (e.g., stored in memory) are incremented for the appropriate server and client. Otherwise, thread tracking continues as normal (block 115).

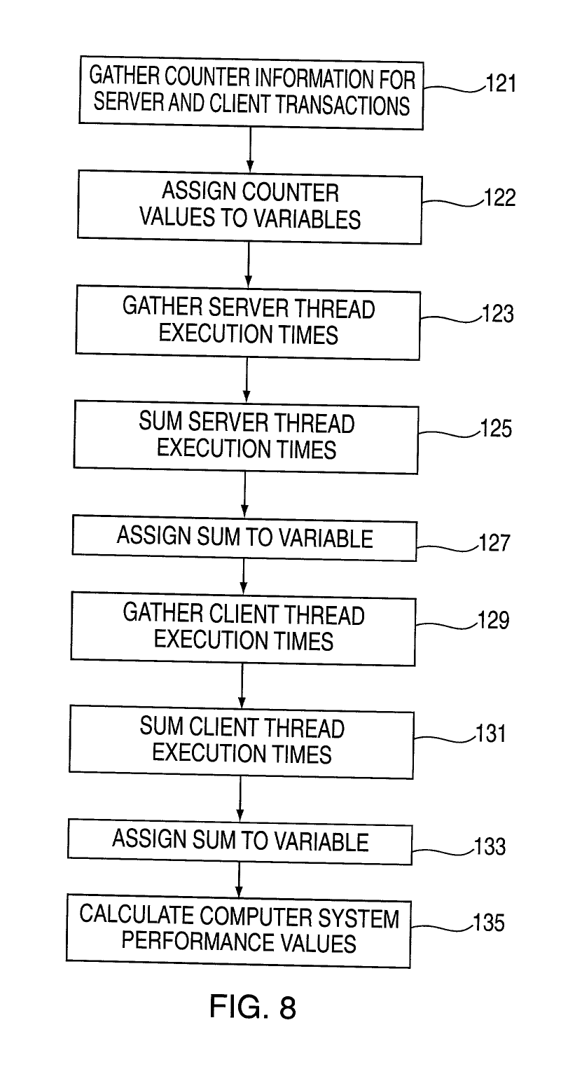

Referring back to FIG. 1, once the client and server threads have executed for a desired amount of time, the thread execution data that has been collected can be used to generate performance data for the computer system under test (block 23). Referring to FIG. 8, a flow diagram is shown of how protocol performance data is generated according to an embodiment of the present invention. In block 121, counter information for the number of transactions completed for each client and server is gathered. In block 122, these values are assigned to variables. For example, if there is one server, then the number of transactions can be assigned to Nₛₑᵣᵥₑᵣ. In block 123, the thread execution times for each server thread are gathered. In block 125, these thread execution times are summed and if there is only one server contemplated, can be assigned to the value Tₛₑᵣᵥₑᵣ (block 127). In block 129, the thread execution times for each client thread are gathered. In block 131, the thread execution times are summed on a client by client basis. In block 133, the summed value(s) is/are assigned to a variable. If there is one client, the sum can be assigned to T_{client}. In block 135, performance values for the computer system under test are calculated.

As described above, the computer system under test is executing server code as well as client code. According to an embodiment of the present invention, the performance of the computer system under test, as a server, is calculated based on the execution times for the server code and for the client code. It may also be calculated based on the number of transactions that are completed between the server and the client(s). Thus, the performance of the computer system under test, acting solely as a server may be calculated as follows:

$${P}_{server} = \frac{{N}_{server} / {T}_{server}}{{T}_{server} / ( {T}_{server} / ( {T}_{server} + {T}_{client} ) )} \qquad \text{(Eq. 1)}$$

From Eq. 1, it can be seen that the numerator is the number of transactions for the server per the processor execution time for server threads (e.g., per millisecond). The numerator is modified by the scaling factor in the denominator which increases the numerator by a value commensurate with removing the effect of processor execution time taken up by client threads. In Eq. 1 it is assumed that there is only one server and one client. If multiple clients are to be used, then T_{client} would represent the cumulative processor execution time for all client threads. In this embodiment, the performance of the server is being measured with respect to handling data packets according to one or more protocols. Accordingly, the execution time for scheduler threads is ignored in this embodiment.

The computer system under test could also be used solely as a client. The performance of the computer system under test acting solely as a client may be calculated as follows:

$${P}_{client} = \frac{{N}_{client} / {T}_{client}}{{T}_{client} / ( {T}_{client} / ( {T}_{server} + {T}_{client} ) )} \qquad \text{(Eq. 2)}$$

From Eq. 2, the numerator represents the number of transactions for the client per processor execution time for the client threads. This value is then augmented by a scaling factor in the denominator to account for the time the processor was executing server thread. Eq. 2 assumes one server and one client. If there is more than one client, then the value for Tₛₑᵣᵥₑᵣ would have to take into account the execution time for the other client threads (e.g., T_{client} would be the execution time for client 1 and Tₛₑᵣᵥₑᵣ would be the execution time for the server in addition to the execution time for clients 2 through n (where n is an integer). Again, according to this embodiment, the performance of the client is measured with respect to handling data packets according to one or more protocols, and scheduler thread execution time is ignored.

Although several embodiments are specifically illustrated and described herein, it will be appreciated that modifications and variations of the present invention are covered by the above teachings and within the purview of the appended claims without departing from the spirit and intended scope of the invention.

What is claimed is:

1. A method for testing a computer system to be operated in a multi-computer environment, comprising:
executing server code at a computer system under test;
executing client code at said computer system under test; and
calculating performance data for said computer system under test.

2. The method of claim 1 further comprising:
tracking an execution time for each of said threads by a processor in said computer system under test; and
tracking a number of transactions completed between the execution of server code and the execution of client code wherein said performance data is based on said number of transactions completed over a period of time.

3. A method for testing a computer system to be operated in a multi-computer environment, comprising:
executing server code at a computer system under test according to a multicomputer communication protocol;
executing client code on said computer system under test according to said multicomputer communication protocol; and
calculating performance data for said computer system under test operating as one of a server and a client.

4. The method of claim 3 wherein said server code and client code includes a number of threads, the method further comprising:
tracking an execution time for each of said threads by a processor in said computer system under test.

5. The method of claim 4 wherein said multicomputer communication protocol defines transactions between said server and said client, the method further comprising:
tracking a number of transactions completed between the execution of server code and the execution of client code.

6. The method of claim 5 wherein said performance data is based on said number of transactions completed over a period of time.

7. The method of claim 6 wherein said performance data is based on said number of transaction completed over said period of time modified by a scaling factor.

8. The method of claim 7 wherein said scaling factor is a total execution time for both client and server threads divided by one of an execution time for said server threads and an execution time for said client threads.

9. A set of instructions residing in a storage medium, said set of instructions capable of being executed by a processor to implement a method for testing a computer sytem to be operated in a multi-computer environment, the method comprising:
executing server code at a computer system under test;
executing client code at said computer system under test; and
calculating performance data for said computer system under test.

10. The set of instructions of claim 9, the method further comprising:
tracking an execution time for each of said threads by a processor in said computer system under test; and
tracking a number of transactions completed between the execution of server code and the execution of client code wherein said performance data is based on said number of transactions completed over a period of time.

11. A set of instructions residing in a storage medium, said set of instructions capable of being executed by a processor to implement a method for testing a computer sytem to be operated in a multi-computer environment, the method comprising:
executing server code at a computer system under test according to a multicomputer communication protocol;
executing client code on said computer system under test according to said multicomputer communication protocol; and
calculating performance data for said computer system under test operating as one of a server and a client.

12. The set of instructions of claim 11 wherein said server code and client code includes a number of threads, the method further comprising:
tracking an execution time for each of said threads by a processor in said computer system under test.

13. The set of instructions of claim 12 wherein said multicomputer communication protocol defines transactions between said server and said client, the method further comprising:
tracking a number of transactions completed between the execution of server code and the execution of client code.

14. The set of instructions of claim 13 wherein said performance data is based on said number of transactions completed over a period of time.

15. The set of instructions of claim 14 wherein said performance data is based on said number of transaction completed over said period of time modified by a scaling factor.

16. The set of instructions of claim 15 wherein said scaling factor is a total execution time for both client and server threads divided by one of an execution time for said server threads and an execution time for said client threads.

17. A computer system under test to be operated in a multi-computer environment, comprising:
a processor to execute server code and client code at said computer system under test according to a multicomputer communication protocol, said computer system uner test to calculate performance data for said computer system under test operating as one of a server and a client.

18. The computer system of claim 17 wherein said server code and client code includes a number of threads, and the computer system under test is to track an execution time for each of said threads by said processor.

19. The computer system of claim 18 wherein said multicomputer communication protocol defines transactions between said server and said client, and the computer system under test is to track a number of transactions completed between the execution of server code and the execution of client code.

20. The computer system of claim 19 wherein said performance data is based on said number of transactions completed over a period of time.

21. The computer system of claim 20 wherein said performance data is based on said number of transaction completed over said period of time modified by a scaling factor.

22. The computer system of claim 21 wherein said scaling factor is a total execution time for both client and server threads divided by one of an execution time for said server threads and an execution time for said client threads.
